(19) United States
(12) Patent Application Publication
(10) Pub. No.: US 2004/0242335 A1
(43) Pub. Date: Dec. 2, 2004

(54) Fluid coupling device for vehicle

(75) Inventor: Tsunekazu Yamauchi, Aichi-ken (JP)

Correspondence Address: BURNS DOANE SWECKER & MATHIS L L P, POST OFFICE BOX 1404, ALEXANDRIA, VA, 22313-1404, US

(73) Assignee: Aisin Seiki Kabushiki Kaisha, Kariya-shi (JP)

(21) Appl. No.: 10/804,166

(22) Filed: Mar. 19, 2004

(30) Foreign Application Priority Data
Mar. 19, 2003 (JP) 2003-075492

(51) Int. Cl. F16D 3/80

(52) U.S. Cl. 464/24

(57) ABSTRACT

A fluid coupling device comprising, a drive shaft rotated by a rotational torque of an driving source; a case rotatably supported on the drive shaft and forming a space, a rotor disposed in the space and fixed to the drive shaft and forming a fluid reservoir chamber, an operation chamber formed between the rotor and the case, a flow passage communicating with the fluid reservoir chamber, a flow hole formed in the rotor and the operation chamber, a valve disposed in the fluid reservoir chamber for operating the opening and closing of the flow hole, a rod rotatably disposed in the drive shaft and fixed to the valve, a magnet integrally rotated with the rod and a coil that generates a force in opposite direction to a rotational direction of the drive shaft.

### CROSS REFERENCE TO RELATED APPLICATIONS

This application is based on and claims priority under 35 U.S.C. § 119 with respect to Japanese Patent Application 2003-075492, filed on Mar. 19, 2003, the entire content of which is incorporated herein by reference.

### FIELD OF THE INVENTION

This invention generally relates to a fluid coupling device for a vehicle, and more particularly to a fluid coupling device which is capable of controlling a volume of an engine cooling airflow.

### BACKGROUND OF THE INVENTION

Even a temperature of an engine cooling water is low, when a pressure of cooling medium is high, cooling airflow needs to be sent to a front portion of a vehicle such as an air conditioning condenser disposed in a front side of a radiator.

Therefore, an engine cooling fan is used in combination with a fluid coupling device in order that rotation of the engine cooling fan is suitably controlled and that cooling airflow is sent to the radiator and the air conditioning condenser.

The fluid coupling device includes a drive shaft which is rotated by an engine power, a rotor as a driven member which is disposed in a cover located in a fan side and is rotated by the drive shaft, an operation chamber as a labyrinth portion which is disposed between the rotor and a case, a flow passage where silicon oil as a viscous fluid is circulated between a reservoir chamber of the silicon oil and the operation chamber, a slide valve for opening and closing a port which is formed at the rotor as a part of the flow passage, and a bimetal for opening and closing the slide valve in response to the temperature change.

A conventional fluid coupling device described above is disclosed in Japanese Patent Laid-Open Publication No.1987-147129 and Japanese Patent Laid-Open Publication No. 2000-130166.

A bimetal disclosed in the Publications is disposed in centrally outside of a case, one end of the bimetal is engaged with a shaft by a slide valve. The bimetal is deformed by supplying electric power to the bimetal, and the slide valve is opened or closed by utilizing the deformation of the bimetal.

An opening or closing operation of the slide valve described above is performed by supplying electric power to the bimetal via a contact type connecting portion from outside. Therefore abrasion of the connecting portion, complexity of the structure and increase in size may occur.

A need thus exists for providing an improved fluid coupling device which satisfies the needs described above.

### SUMARRY OF THE INVENTION

According to an aspect of the present invention, a fluid coupling device comprising, a drive shaft rotated by a rotational torque of an driving source; a case rotatably supported on the drive shaft and forming a space, a rotor disposed in the space and fixed to the drive shaft and forming a fluid reservoir chamber, an operation chamber formed between the rotor and the case, a flow passage communicating with the fluid reservoir chamber, a flow hole formed in the rotor and the operation chamber, a valve disposed in the fluid reservoir chamber for operating the opening and closing of the flow hole, a rod rotatably disposed in the drive shaft and fixed to the valve, a magnet integrally rotated with the rod and a coil that generates a force in opposite direction to a rotational direction of the drive shaft.

### BRIEF DISCRIPTION OF THE DRAWING FIGURES

The foregoing and additional features and characteristics of the present invention will become more apparent from the following detailed description considered with reference to the accompanying drawing figures wherein:

FIG. 1 is a cross sectional view illustrating an embodiment of a fluid coupling device of the present invention;

FIG. 2 is a front view illustrating a condition of flow holes closed by a slide valve of the fluid coupling device; and

FIG. 3 is a front view illustrating a relationship between a magnetic body and an electric circuit of the fluid coupling device.

### DETAILED DESCRIPTION OF THE INVENTION

A fluid coupling device 1 includes a drive shaft 2 which is rotated by receiving a rotation torque from an engine (not shown). A case 4 is supported to the drive shaft 2 through a bearing 3. The case 4 is including a driven side case 4a and a drive side case 4b. A hermetic space 5, which accommodates a rotor 7, is defined between the driven side case 4a and the drive side case 4b. Viscous fluid material such as silicon oil is installed in the hermetic space 5. A not shown fan is fixed to the driven side case 4a by using bolts 6.

The rotor 7 which is fixed to one end of the drive shaft 2 is disposed in the hermetic space 5. The rotor 7 includes a driven side rotor 7a and a drive side rotor 7b. The drive side rotor 7b and the driven side rotor 7a are fixed each other. A reservoir chamber 8 is formed between the drive side rotor 7b and the driven side rotor 7a. A flow passage 12 is formed between the drive side rotor 7b and the driven side rotor 7a.

The viscous fluid in the reservoir chamber 8 can circulate through the flow passage 12 which goes through flow holes 9 formed in the driven side rotor 7a and the drive side rotor 7b, an operation chambers 10, 10 and a passage 11. The operation chambers 10, 10, constituting a known labyrinth structure to establish rotating force of the case 4.

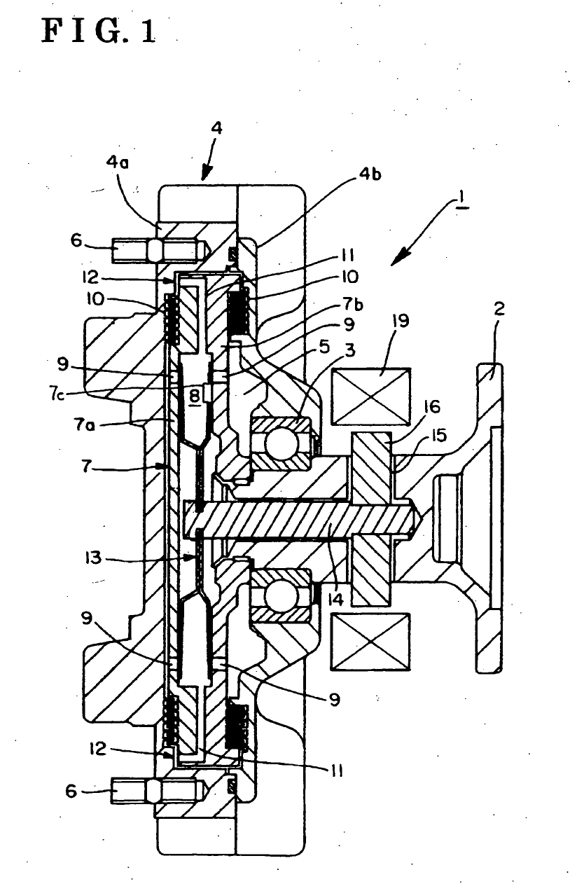

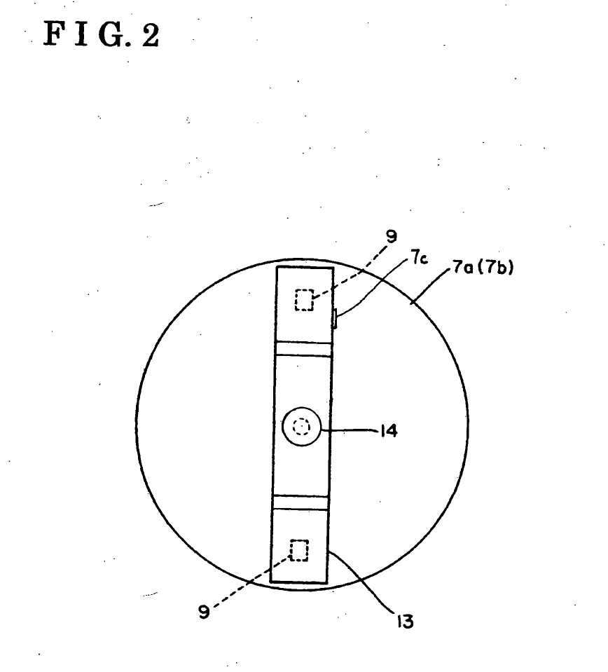

A sliding valve 13 is disposed in the reservoir chamber 8 and is being fixed integrally to an end of the rod 14. The sliding valve 13 operates a fluid flow between the hermetic space 5 and reservoir chamber 8. The flow holes 9 are normally closed by the slide valve 8. As illustrated in FIG. 2, the slide valve 13 is of a rectangular shape seen from a front side. As illustrated in FIG. 1, two plates are overlapped each other in the middle of the longitudinal direction, and both ends of the plates are separated from each other and are opposed and contacted to the flow holes 9.

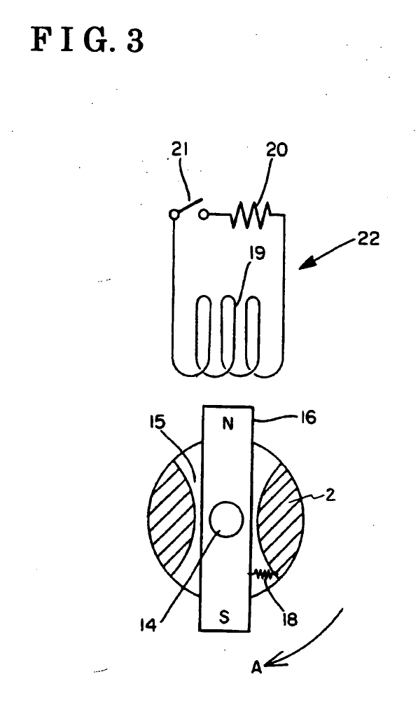

A rod 14 is rotatably mounted on a central hole of the drive shaft 2. A rectangular magnet 16, which is rotatably mounted on the rod 14, disposed in a hole 15 extending in radial direction of the drive shaft 2. The magnet 16 extending outside of an outer surface of the drive shaft is connected with the drive shaft 2 via a spring (an elastic body) 18. The spring 18 is installed between the magnetic 16 and the drive shaft 2 with shrinking the width of the spring 18. In other words, the spring 18 is biased and urging the sliding valve 13 into a closing condition through the rectangular magnet 16 and the rod 14. The slide valve 13 is being urged in the direction that the sliding valve 13 contacts with a stopper 7c formed on the drive side rotor 7b. A coil 19 is arranged around the outer peripheral of the rectangular magnet 16. As illustrated in FIG. 3, a electric circuit 22 is including a switch 21, a resistance 20 and the coil 19. In this configuration, the electric circuit 22 applying braking force when the magnet 16 rotates.

When the engine (not shown) stops and the switch 21 is turned off position, the flow holes 9 are closed by the sliding valve 13. In this condition, the viscous fluid does not flow into the operation chambers 10,10, the case 4 dose not receive rotating force.

When the engine rotates under a condition that the switch 21 is turned off position, the drive shaft 2 is rotated in “A” direction shown in the FIG. 3. According to this rotation of the driving shaft 2, the rotor 7 is rotated with the driving shaft 2. However, in this condition, since the urging force of the spring 18 is applied to the sliding valve 13, the flow holes 9 are closed. As a result, the viscous fluid remaining in the operation chamber 10 flows into the reservoir chamber 8 through the passage 11. Therefore, the viscous fluid is not circulated via the operation chamber 10 and the flow passage 12, so coupling force between the case 4 and the rotor 7 dose not generate. Under the above described condition, rotation of the drive shaft 2 is transmitted to the magnet 16 through the spring 18. Although the magnet 16 rotates, the slide valve 13 keeps a closed position.

The magnet 16 rotates in the “A” direction under the condition that the switch 21 is turned on and the electric circuit 22 establishes closed circuit, the magnetic flux is generated in the coil 19. According to this magnetic flux, an energization force is generated in the closed electric circuit 22, and the magnet 16 receives a reverse force relative to the “A” direction.

When the reverse force to the magnet 16 exceeds a biasing force of the spring 18, the magnet 16 rotates in the reverse direction relative to the rotation direction of the drive shaft 2. The reverse rotation of the magnet 16 is transmitted to the rod 14. The rod 14 deforms the spring 18, and the slide valve 13 is moved to an open position.

When the sliding valve 13 is moved to the open position, according to the rotation of the rotor 7, the viscous fluid is circulated through the operation chamber 10, the passage 11, the reservoir chamber 8 and the flow holes 9. This circulation enables a rotational torque to be transmitted to the case 4 through the operation chamber 10. Therefore, a fan (not shown) fixed to the case 4 is rotated.

When the switch 21 is turned off during engine rotating condition, the energization force is no more generated, and the magnetic body 16 is returned to the original position by the spring 18. Additionally, the slide valve 13 and the rod 14 are returned to the original position corresponding to the valve closed position. Closing the flow holes 9 reduces the transmission of the rotational torque, as the result the rotation of the fan (not shown) is stopped.

The principles, a preferred embodiment and mode of operation of the present invention have been described in the foregoing specification and drawings. However, the invention which is intended to be protected is not to be construed as limited to the particular embodiment disclosed. Further, the embodiments described herein are to be regarded as illustrative rather than restrictive. Plural objectives are achieved by the present invention, and yet there is usefulness in the present invention as far as one of the objectives are achieved. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A fluid coupling device comprising;
a drive shaft rotated by a rotational torque of an driving source;
a case rotatably supported on the drive shaft and forming a space;
a rotor disposed in the space and fixed to the drive shaft and forming a fluid reservoir chamber;
an operation chamber formed between the rotor and the case;
a flow passage communicating with the fluid reservoir chamber, a flow hole formed in the rotor and the operation chamber;
a valve disposed in the fluid reservoir chamber for operating the opening and closing of the flow hole;
a rod rotatably disposed in the drive shaft and fixed to the valve;
a magnet integrally rotated with the rod; and
a coil that generates a force in opposite direction to a rotational direction of the drive shaft.

2. A fluid coupling device according to claim 1, further comprising;
an elastic member is disposed between the magnet and the drive shaft wherein the valve is biased in a closing direction.

3. A fluid coupling device according to claim 1 wherein the flow hole is closed by the valve when electric supply to the coil is turned off.

4. A fluid coupling device according to claim 1, further comprising;
the coil is connected a switch that establishes a electrically closed circuit.
